(19) United States
(12) Patent Application Publication
(10) Pub. No.: US 2026/0169447 A1
(43) Pub. Date: Jun. 18, 2026

(54) Adaptive Controller Scheduling Framework for Semiconductor Devices

(71) Applicant: Google LLC, Mountain View, CA (US)

(72) Inventors: Mohsen Heidarinejad, San Jose, CA (US); Arpit Mittal, San Jose, CA (US)

(73) Assignee: Google LLC, Mountain View, CA (US)

(21) Appl. No.: 18/978,960

(22) Filed: Dec. 12, 2024

(51) Int. Cl. G05B 13/04; G05B 13/02

(52) U.S. Cl. CPC G05B 13/048; G05B 13/0265

(57) ABSTRACT

Aspects of adaptive controller scheduling frameworks for semiconductor devices are disclosed. A controller coupled with an element of a semiconductor device is configured to control operating properties (e.g., temperature, power consumption, performance state) of the element. An agent determines an estimated operation region of the element based on one or more of the operating properties. A prediction model determines a future performance state based on usage behavior of an electronic device utilizing the semiconductor device and one or more of the operating properties. A logic unit determines a logic decision based on the estimated operation region and future performance state. A transition unit determines revised operating parameters based on the logic decision and the operating properties of the element and communicates the revised operating parameters to the controller to control the element. The transition unit may ensure a smooth transition of the element to revised operating properties.

### BACKGROUND

Semiconductor devices are widely used throughout the world in various electronic devices. It is estimated that almost 80% of the world's population owns a mobile phone, which is one type of electronic device. One semiconductor device used within electronic devices is a system-on-a-chip (SoC), which may include various elements, such as a central processing unit (CPU), a graphic processing unit (GPU), an accelerated processing unit (APU), an audio processing unit, and a tensor processing unit (TPU).

The various elements of a semiconductor device (e.g., CPU, GPU) within an electronic device may cause a rise in temperature within the semiconductor device, which may apply stress or reduce performance of the semiconductor device when the temperature is too high. Electronic devices may include fixed thermal control policies that are applied to elements of the semiconductor device. Fixed thermal control policies may be applied to one or more elements of a semiconductor device in an effort to control potential thermal issues and/or potential performance issues. However, fixed thermal control policies are static and thus cannot adapt to the usage behavior of an electronic device that includes the semiconductor device. Further, applying a fixed thermal control policy to one or more elements of the semiconductor device may cause noticeable negative consequences to the user experience of the electronic device. For example, a fixed thermal control policy may demand elements of the semiconductor device change instantly from one operation region to another operation region, which may cause a noticeable change in performance such as dimming a display or potentially causing the electronic device to shut down.

### SUMMARY

This document describes systems and techniques directed at an adaptive controller scheduling framework for semiconductor devices, which may overcome or reduce the disadvantages of applying a fixed thermal control policy. For example, an adaptive controller scheduling framework provides a scheduling framework for a controller to provide adaptive throttling actions to an element enabling a smooth transition between operation points of the element. A smooth transition, as used herein, means an element transitions between two operation points without a user experiencing a noticeable decline in performance and/or user experience. In order to make a smooth transition, the controller scheduling framework may need to implement a series of throttling steps, based on a usage history and operation properties, to an element to transition it from one operation point to another. For example, the controller scheduling framework may decrease the temperature of an element from a first temperature to a second temperature in a series of steps rather than attempting to force the element to transition directly (e.g., immediately) to the second temperature.

Aspects of an adaptive controller scheduling framework for semiconductor devices are disclosed. For example, a controller is coupled with an element of a semiconductor device. The controller is configured to control operating properties (e.g., temperature, power consumption, performance state) of the element. An agent coupled with the element determines an estimated operation region of the element based on one or more of the operating properties. A prediction model coupled with the element determines a future performance state based on usage behavior of an electronic device utilizing the semiconductor device and one or more of the operating properties. A logic unit coupled with the agent and the prediction model determines a logic decision based on the estimated operation region and future performance state. A transition unit coupled with the logic unit and the controller determines revised operating parameters based on the logic decision and the operating properties of the element and communicates the revised operating parameters to the controller to control the element. The transition unit may ensure a smooth transition of the element to revised operating properties.

In some aspects, the techniques described herein relate to a method including receiving, at a transition unit, a first logic decision from a logic unit, the first logic decision based on a first estimated operation region and a first future performance state of a first element associated with a semiconductor. The first logic decision indicates a transition of the first element from the first estimated operation region to the first future performance state. The method including receiving, at the transition unit, a first temperature of the first element, a first power consumption of the first element, and a first performance state residency of the first element. The method including determining, by the transition unit, first revised operating parameters of a first controller coupled with the first element and the transition unit, the first revised operating parameters determined based on the first temperature, the first power consumption, the first performance state residency, and the first logic decision. The method including applying the first revised operating parameters to the first controller, the applying effective to transition the first element from the first estimated operation region to the first future performance state.

In some aspects, the techniques described herein relate to a system including a first element of a semiconductor device. The first element has a first temperature, a first power consumption, and a first performance state residency. The system including a first agent coupled with the first element. The first agent is configured to receive the first temperature, the first power consumption, and the first performance state residency from the first element and determine a first estimated operation region of the first element based on at least one of the first temperature, the first power consumption, and the first performance state residency. The system including a first prediction model coupled with the first element. The first prediction model is configured to receive the first temperature, the first power consumption, and the first performance state residency from the first element and determine a first future performance state of the first element determined based on usage behavior of an electronic device utilizing the semiconductor device and at least one of the first temperature, the first power consumption, and the first performance state residency.

The system including a first logic unit coupled with the first agent and the first prediction model. The first logic unit is configured to receive the first estimated operation region from the first agent and the first future performance state from the first prediction model and determine a first logic decision based on the first estimated operation region and the first future performance state. The first logic decision indicates a transition of the first element from the first estimated operation region to the first future performance state. The system including a first transition unit coupled with the first logic unit and the first element. The first transition unit is configured to receive the first logic decision from the first logic unit and the first temperature, the first power consumption, and the first performance state residency from the first element and to determine, based on the first logic decision, the first temperature, the first power consumption, and the first performance state residency, first revised operating parameters. The system including a first controller coupled with the first transition unit and the first element. The first controller is configured to receive the first revised operating parameters from the first transition unit and apply a first throttling action to the first element based on the first revised operating parameters. The application of the first throttling action to the first element is effective to change an operation point of the first element.

In some aspects, the techniques described herein relate to one or more non-transitory computer storage media encoded with instructions that when executed by a computing device cause the computing device to perform operations. The operations including determining, by an agent coupled with an element of a semiconductor device, an estimated operation region of the element, the estimated operation region determined based on one or more of a temperature of the element, a power consumption of the element, and a performance state residency of the element. The operations including determining, by a prediction model coupled with the element, a future performance state of the element. The future performance state of the element is determined based on usage behavior of an electronic device that includes the semiconductor device and one or more of a temperature of the element, a power consumption of the element, and a performance state residency of the element.

The operations including determining, by a logic unit coupled with the agent and the prediction model, a logic decision determined based on the estimated operation region of the element and the future performance state of the element. The logic decision indicates a transition of the element from the estimated operation region to the future performance state. The operations including determining, by a transition unit coupled with the logic unit and the element, revised operating parameters for a controller coupled with the element, the revised operating parameters determined based on the logic decision, the temperature of the element, the power consumption of the element, and the performance state residency of the element. The operations including applying the revised operating parameters to the controller, the applying effective to transition the element from the estimated operation region to the future performance state.

This Summary is provided to introduce simplified concepts of an adaptive controller scheduling framework for semiconductor devices, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at adaptive controller scheduling frameworks for semiconductor devices are described in this document with reference to the following drawings, in which the use of same numbers in different instances may indicate similar features or components.

FIG. 1 illustrates an example system in which aspects of adaptive controller scheduling frameworks for semiconductor devices can be implemented.

FIG. 2 illustrates an example system in which aspects of adaptive controller scheduling frameworks for semiconductor devices can be implemented.

FIG. 3 illustrates an example system in which aspects of adaptive controller scheduling frameworks for semiconductor devices can be implemented.

FIG. 4 illustrates an example system in which aspects of adaptive controller scheduling frameworks for semiconductor devices can be implemented.

FIG. 5 illustrates an example operating environment in which aspects of adaptive controller scheduling frameworks for semiconductor devices can be implemented.

FIG. 6 illustrates an integrated circuit component in which aspects of adaptive controller scheduling frameworks for semiconductor devices can be implemented.

FIG. 7 illustrates an example electronic device having internal hardware configurations for adaptive controller scheduling frameworks for semiconductor devices in accordance with one or more implementations.

FIG. 8 is a flowchart of a method for adaptive controller scheduling frameworks for semiconductor devices.

### DETAILED DESCRIPTION

### Overview

Electronic devices may include one or more semiconductor devices that apply a fixed thermal control policy to the various elements of the semiconductor device. The fixed thermal control policy may be implemented to prevent the operation of an element from creating a thermal issue (e.g., overheating) of the electronic device. The fixed thermal control policy may throttle an element (e.g., reduce the operation point of the element; lower the operating frequency of the element) to reduce power consumption of the element and/or prevent a temperature of the element from exceeding a temperature threshold (e.g., temperature target). However, the fixed thermal control policy may not be optimized based on usage behavior of the electronic device. Further, fixed thermal control policies may not provide for smooth transitions between the current operation point and a future estimated operation point.

For example, the fixed thermal control policy may cause an element to transition directly (e.g., immediately) to a new operation point to lower the temperature of the element to a new temperature target. The sudden transition of the element may cause a reduction in the user experience. A sudden transition may cause the brightness of a display to be dimmed or may negatively affect a GPU such that a game being played on the electronic device becomes choppy or experiences lag. A sudden transition between operation points may even cause the electronic device to shut down. Fixed thermal control policies are not configured to ensure an element has a smooth transition when being throttled. Instead, fixed thermal control policies are typically set to ensure a target (e.g., temperature target, power consumption target, or the like) is not exceeded by an element of the semiconductor device. The fixed thermal control policies throttle an element when a target is exceeded and do not provide any mechanisms to ensure that the transition of the element is smooth.

To this end, this document describes systems and techniques directed to an adaptive controller scheduling framework for semiconductor devices that ensure elements smoothly transition between operation points while being throttled by a controller.

The techniques described herein may include a transition unit that dynamically generates revised operating parameters to smoothly transition an operation point of an element of a semiconductor device to a revised operation point. The transition unit determines revised operating parameters based on a temperature, power consumption, and residency state of the element along with a logic decision from a logic unit. The logic decision indicates a transition of the element based on an estimated operating region received from an agent coupled with the element and a future performance state received from a prediction model coupled with the element. The estimated operating region is determined based on one or more of the temperature, the power consumption, and the residency state of the element. The future performance state of the element is determined based on usage behavior of an electronic device that utilizes the semiconductor device and one or more of the temperature, the power consumption, and the residency state of the element. The usage behavior may be determined by a machine-learned model or by artificial intelligence. The usage behavior may be communicated to the prediction model from a machine-learned model, or artificial intelligence may be integrated within the prediction model.

The transition unit may utilize usage behavior to determine revised operating parameters communicated to the controller to revise the operation point of the element. Likewise, the logic unit may also utilize usage behavior in addition to the estimated operating region and future performance state to determine the logic decision. For example, a machine-learned model or artificial intelligence may provide the usage behavior to these elements of the controller scheduling framework.

The transition unit may be configured to ensure that the controlled element transitions smoothly from the present operating point to the revised operating point that is determined by the revised operating parameters provided to the controller by the transition unit. For example, the transition unit may provide a series of revised operating parameters so that the controller transitions the element in a series of steps to the revised operation point. The series of steps may be linear or non-linear as would be appreciated by one of ordinary skill in the art having the benefit of this disclosure. For example, the element may have a present temperature of 80 degrees Celsius and, based on the revised operating parameters, the controller may be instructed a new temperature target of 70 degrees Celsius. The controller may cause the element to reduce the temperature of the element to 70 degrees Celsius in a series of steps instead of instantaneously attempting to reduce the temperature of the element from 80 degrees Celsius to 70 degrees Celsius. Instead, the controller may reduce the temperature of the element to 78 degrees Celsius for a first predetermined timescale, reduce the temperature of the element to 75 degrees Celsius for a second predetermined timescale, and finally reduce the temperature of the element to the target temperature of 70 degrees Celsius. Various numbers of steps to revise an operating property of the element may be used as would be appreciated by one of ordinary skill in the art having the benefit of this disclosure.

The following discussion describes operating environments, techniques that may be employed in the operating environments, and example methods. Although techniques using and apparatuses for an adaptive controller scheduling framework for semiconductor devices are described, it is to be understood that the subject of the appended claims is not necessarily limited to the specific features or methods described. Rather, the specific features and methods are disclosed as example implementations and reference is made to the operating environment by way of example only.

### Example Systems and Operational Schemes

An adaptive controller scheduling framework for semiconductor devices is able to repurpose controllers within a system to effectively transition an element (e.g., CPU, GPU, TPU, APU, or the like) of a semiconductor device from a real-time operation point to a future performance state. The future performance state may be determined based on usage behavior of an electronic device utilizing the semiconductor device along with real-time operating properties (e.g., temperature, power consumption, performance state residence) of the element. A machine-learned model and/or artificial intelligence may be used to determine the usage behavior. As a result, the adaptive controller scheduling framework can be configured to ensure a smooth transition of the element between the operating states.

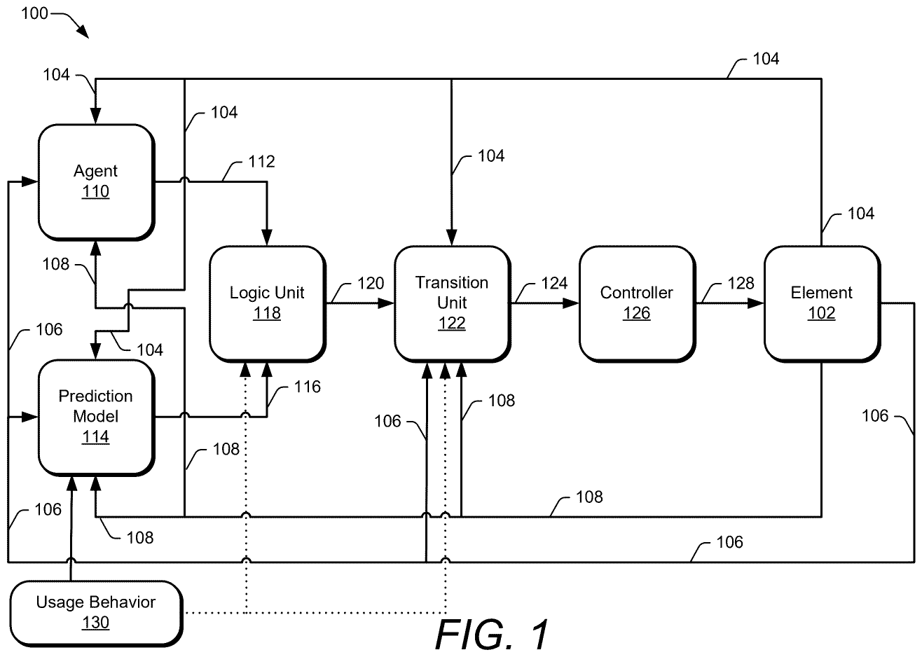

FIG. 1 illustrates an example system 100 that implements aspects of adaptive controller scheduling frameworks for semiconductor devices. The system 100 includes an element 102 of a semiconductor device. The element 102 includes a temperature 104, a power consumption 106, and a performance state residency 108. The temperature 104 may be the real-time temperature of the element 102. The power consumption 106 may be the real-time consumption of power by the element 102. The performance state residency 108 of the element 102 is the history of the performance state of the element 102. The operating properties (e.g., temperature 104, power consumption 106, performance state residency 108) of the element 102 are determined based on an operation point of the element 102. The operating properties may be the real-time operating properties of the element 102 based on the operation point of the element 102. At an operation point, the element 102 operates at a specific operating frequency, and the temperature 104, power consumption 106, and performance state residency 108 may be dependent on the operation point of the element 102.

The element 102 is coupled with an agent 110 and a prediction model 114. The temperature 104, power consumption 106, and performance state residency 108 are communicated from the element 102 to both the agent 110 and the prediction model 114. Based on at least one of the operating properties (e.g., temperature 104, power consumption 106, performance state residency 108) of the element 102, the agent 110 determines an estimated operation region 112 of the element 102. The estimated operation region 112 is communicated to a logic unit 118 coupled with the agent 110. In one aspect, the agent 110 may determine the estimated operation region 112 based on two out of the three operating properties (e.g., temperature 104, power consumption 106, performance state residency 108) of the element 102. In another aspect, the agent 110 may determine the estimated operation region 112 based on all three of the operating properties (e.g., temperature 104, power consumption 106, performance state residency 108) of the element 102.

The prediction model 114 determines a future performance state 116 of the element 102 based on a usage behavior 130 and at least one of the operating properties (e.g., temperature 104, power consumption 106, performance state residency 108) of the element 102. The usage behavior 130 may be usage behavior of an electronic device that utilizes the semiconductor device. The usage behavior 130 may be provided to the prediction model 114 by a machine-learned model. The machine-learned model may be a standard neural-network-based model with corresponding layers required for processing input features like fixed-side vectors, text embeddings, or variable length sequences. The machine-learned model may be implemented as one or more of a support vector machine (SVM), a recurrent neural network (RNN), a convolutional neural network (CNN), a dense neural network (DNN), one or more heuristics, other machine-learning techniques, a combination thereof, and so forth. In other aspects, the usage behavior 130 may be provided to the prediction model 114 by artificial intelligence. The machine-learned model and/or the artificial intelligence may be integrated within the prediction model 114 or may be an element coupled with the prediction model 114.

In one aspect, the prediction model 114 may determine the future performance state 116 based on the usage behavior 130 and at least two of the operating properties (e.g., temperature 104, power consumption 106, performance state residency 108) of the element 102. In another aspect, the prediction model 114 may determine the future performance state 116 based on the usage behavior 130 and all three of the operating properties (e.g., temperature 104, power consumption 106, performance state residency 108) of the element 102. The future performance state 116 is communicated from the prediction model 114 to the logic unit 118 coupled with the prediction model 114. Likewise, the estimated operation region 112 is communicated from the agent 110 to the logic unit 118 that is also coupled to the agent 110.

The logic unit 118 is configured to determine a logic decision 120 based on the estimated operation region 112 received from the agent 110 and the future performance state 116 received from the prediction model 114. The logic decision 120 indicates whether the element 102 needs to transition from the estimated operation region 112 to the future performance state 116. In one aspect, the logic unit 118 may use the usage behavior 130 in combination with the estimated operation region 112 and the future performance state 116 to determine the logic decision 120. The usage behavior 130 may be provided to the logic unit 118 by artificial intelligence or by a machine-learned model as discussed herein. The usage behavior 130 aids the logic unit 118 in determining a timescale for the transition of the element 102. The logic decision 120 is communicated to a transition unit 122 that is coupled with the logic unit 118.

The transition unit 122 is coupled with the logic unit 118, the element 102, and a controller 126 that is also coupled with the element 102. The controller 126 may be configured to control (e.g., throttle) 128 at least one operation aspect of the element 102. For example, the controller 126 may be a thermal controller configured to control the temperature 104 of the element 102 based on a temperature target. Likewise, the controller 126 may be a power controller configured to control the power consumption 106 of the element based on a power consumption target.

The transition unit 122 receives the logic decision 120 from the logic unit 118 and well as the operating properties (e.g., temperature 104, power consumption 106, performance state residency 108) from the element 102. Based on the logic decision 120 and the operating properties (e.g., temperature 104, power consumption 106, performance state residency 108) of the element 102, the transition unit 122 provides revised operating parameters 124 to the controller 126. The revised operating parameters 124 provided to the controller 126 are configured to transition the element 102 from a present operation point to a new operation point. The revised operating parameters 124 may be configured to ensure a smooth transition of the element 102. For example, the revised operating parameters 124 may provide a series of throttling steps that the controller 126 may apply to the element 102 to smoothly change the operation point of the element 102. The controller 126 may gradually reduce an operating property (e.g., temperature) from a current temperature to a target temperature provided by the transition unit 122 via the revised operating parameters 124.

The revised operating parameters 124 may include a series of revised operating parameters 124 that are communicated to the controller 126 over a set timescale. The transition unit 122 may also repurpose the controller 126 coupled with the element 102. For example, the controller 126 may be a thermal controller configured to control the temperature 104 of the element 102. However, the revised operating parameters 124 may instruct the controller 126 to control 128 (e.g., throttle) the power consumption 106 of the element 102 instead of controlling (e.g., throttling) the temperature 104 of the element 102. The operating parameters 124 may also revise a timescale that the controller 126 has been using to monitor and/or control (e.g., throttle) the element 102. For example, the controller 126 may have been initially configured to monitor the temperature 104 of the element 102 every 100 milliseconds. The revised operating parameters 124 from the transition unit 122 may reconfigure the controller 126 to monitor the temperature 104 of the element 102 every 200 milliseconds or every 50 milliseconds.

The transition unit 122 determines the revised operating parameters 124 based on the operating properties (e.g., temperature 104, power consumption 106, performance state residency 108) of the element 102 as well as the logic decision 120 received from the logic unit 118. In some aspects, the transition unit 122 may also utilize the usage behavior 130 along with the operating properties (e.g., temperature 104, power consumption 106, performance state residency 108) of the element 102 and the logic decision 120 to determine the revised operating parameters 124 that are communicated to the controller 126. The usage behavior 130 may be the usage behavior of an electronic device that utilizes the semiconductor device. The usage behavior 130 may be communicated to the transition unit 122 from artificial intelligence and/or a machine-learned model as discussed herein. The artificial intelligence and/or the machine-learned model may be integral within the transition unit 122 or may be located as external elements as would be appreciated by one of ordinary skill in the art having the benefit of this disclosure.

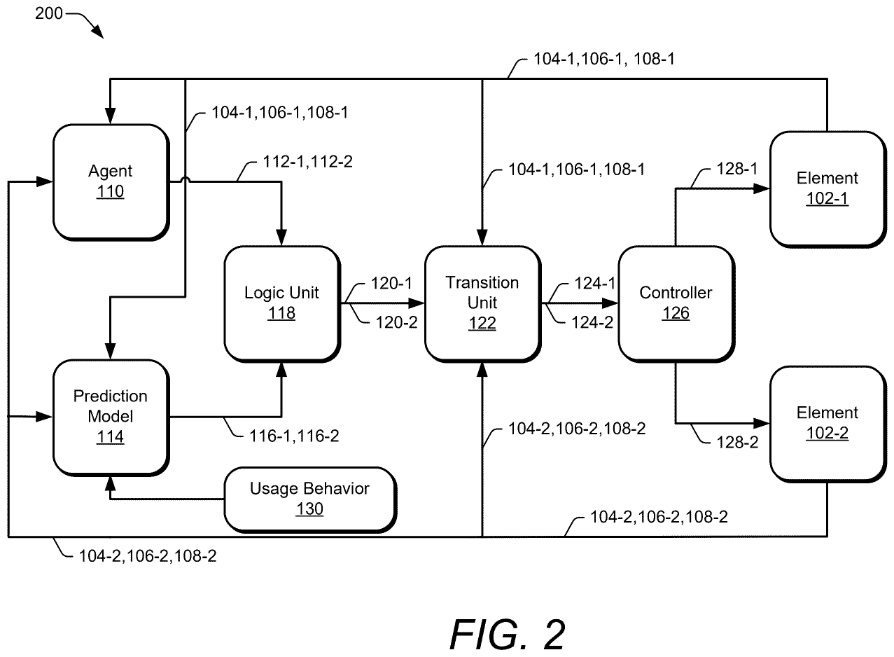

The system 100 of FIG. 1 may be able to implement aspects of an adaptive controller scheduling framework for semiconductor devices. The aspects of control (e.g., throttling) of the controller 126 of the system 100 may be adapted based on the present operating region (e.g., estimated operation region 112) of the element 102 as well as a predicted future performance state (e.g., future performance state 116) of the element 102. The transition unit 122 may be configured to ensure a smooth transition to a revised operating state. FIG. 2 illustrates another aspect of a system 200 that may implement aspects of an adaptive controller scheduling framework for semiconductor devices. FIG. 2 illustrates another system that implements aspects of an adaptive controller scheduling framework of semiconductor devices.

FIG. 2 illustrates a system 200 includes a first element 102-1 and a second element 102-2 of a semiconductor device. The first element 102-1 includes a first temperature 104-1, a first power consumption 106-1, and a first performance state residency 108-1. The second element 102-2 includes a second temperature 104-2, a second power consumption 106-2, and a second performance state residency 108-2. The first operating properties (e.g., first temperature 104-1, first power consumption 106-1, first performance state residency 108-1) of the first element 102-1 are determined based on an operation point of the first element 102-1. Likewise, the second operating properties (e.g., second temperature 104-2, second power consumption 106-2, second performance state residency 108-2) of the second element 102-2 are determined based on an operation point of the second element 102-2.

The system 200 includes a controller 126 that may be configured to control (e.g., throttle) 128-1 at least one operation aspect of the first element 102-1 and to control (e.g., throttle) 128-2 at least one operation aspect of the second element 102-2. For example, the controller 126 may be a thermal controller configured to control the first temperature 104-1 of the first element 102-1 based on a first temperature target and to control the second temperature 104-2 of the second element 102-2 based on a second temperature target.

The first element 102-1 and the second element 102-2 are each coupled with an agent 110 and a prediction model 114. The first temperature 104-1, first power consumption 106-1, and first performance state residency 108-1 are communicated from the first element 102-1 to both the agent 110 and the prediction model 114. Likewise, the second temperature 104-2, second power consumption 106-2, and second performance state residency 108-2 are communicated from the second element 102-2 to both the agent 110 and the prediction model 114. Based on at least one of the first operating properties (e.g., first temperature 104-1, first power consumption 106-1, first performance state residency 108-1) of the first element 102-1, the agent 110 determines a first estimated operation region 112-1 of the first element 102-1. Similarly, the agent 110 determines a second estimated operation region 112-2 of the second element 102-2 based on at least one of the second operating properties. The first estimated operation region 112-1 and the second estimated operation region 112-2 are communicated to a logic unit 118 coupled with the agent 110. As discussed herein, the first estimated operation region 112-1 and the second estimated operation region 112-2 are determined based on one, two, or three of the operating properties of the first element 102-1 and the second element 102-2, respectively.

The prediction model 114 determines a first future performance state 116-1 of the first element 102-1 based on a usage behavior 130 and at least one of the first operating properties (e.g., first temperature 104-1, first power consumption 106-1, first performance state residency 108-1) of the first element 102-1. The prediction model 114 also determines a second future performance state 116-2 of the second element 102-2 based on the usage behavior 130 and at least one of the second operating properties (e.g., second temperature 104-2, second power consumption 106-2, second performance state residency 108-2) of the second element 102-2. The usage behavior 130 may be usage behavior of an electronic device that utilizes the semiconductor device and may be provided to the prediction model 114 by a machine-learned model and/or by artificial intelligence. As discussed herein, the prediction model 114 may use one, two, or three of the operating properties of the first element 102-1 and the second element 102-2 in combination with the usage behavior 130 to determine the first future performance state 116-1 and the second future performance state 116-2, respectively. The first future performance state 116-1 and the second future performance state 116-2 are communicated to the logic unit 118 also coupled with the prediction model 114.

The logic unit 118 is configured to determine a first logic decision 120-1 based on the first estimated operation region 112-1 received from the agent 110 and the first future performance state 116-1 received from the prediction model 114. The logic unit 118 is also configured to determine a second logic decision 120-2 based on the second estimated operation region 112-2 received from the agent 110 and the second future performance state 116-2 received from the prediction model 114. The first logic decision 120-1 indicates whether the first element 102-1 needs to transition from the first estimated operation region 112-1 to the first future performance state 116-1. The logic unit 118 is coupled with a transition unit 122. The logic unit 118 communicates the first logic decision 120-1 and the second logic decision 120-2 to the transition unit 122.

Based on the first logic decision 120-1 and the first operating properties (e.g., first temperature 104-1, first power consumption 106-1, first performance state residency 108-1) of the first element 102-1, the transition unit 122 provides first revised operating parameters 124-1 to the controller 126. The first revised operating parameters 124-1 provided to the controller 126 are configured to transition the first element 102-1 from a present operation point to a new operation point. Based on the second logic decision 120-2 and the second operating properties (e.g., second temperature 104-2, second power consumption 106-2, second performance state residency 108-2) of the second element 102-2, the transition unit 122 provides second revised operating parameters 124-2 to the controller 126. The second revised operating parameters 124-2 provided to the controller 126 are configured to transition the second element 102-2 from a present operation point to a new operation point.

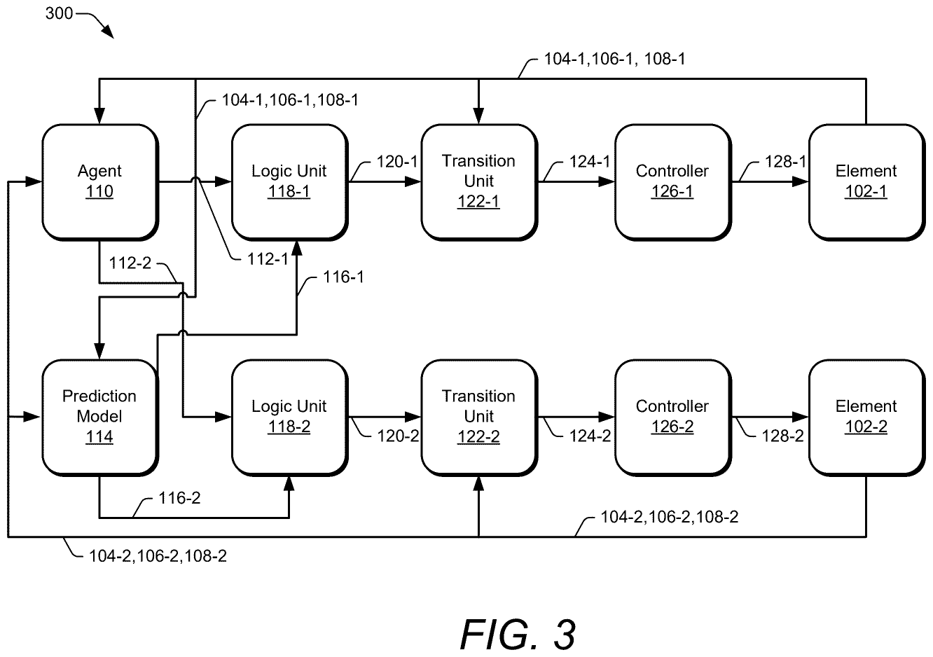

The first revised operating parameters 124-1 and the second revised operating parameters 124-2 may be configured to ensure a smooth transition of the first element 102-1 and the second element 102-2. In an aspect, the first revised operating parameters 124-1 may provide a series of throttling steps that the controller 126 may apply to the first element 102-1 to smoothly change the operation point of the first element 102-1. Likewise, the second revised operating parameters 124-2 may provide a series of throttling steps to smoothly transition the operation point of the second element 102-2. FIG. 3 illustrates another system that implements aspects of an adaptive controller scheduling framework of semiconductor devices.

FIG. 3 illustrates a system 300 that includes a first element 102-1 and a second element 102-2 that are coupled with an agent 110 and a prediction model 114. The agent 110 determines a first estimated operation region 112-1 of the first element 102-1 and a second estimated operation region 112-2 of the second element 102-2 as discussed herein. Likewise, the prediction model 114 determines a first future performance state 116-1 of the first element 102-1 and a second future performance state 116-2 of the second element 102-2 as discussed herein.

The agent 110 communicates the first estimated operation region 112-1 to a first logic unit 118-1 and the prediction model 114 communicates the first future performance state 116-1 to the first logic unit 118-1. The first logic unit 118-1 is coupled with a first transition unit 122-1 that is coupled to a first controller 126-1 configured to control the first element 102-1 as discussed herein. The first logic unit 118-1 communicates a first logic decision 120-1 to the first transition unit 122-1. The first transition unit 122-1 communicates first revised operating parameters 124-1 to the first controller 126-1. The first revised operating parameters 124-1 are determined based on the first logic decision 120-1 and first operation properties (e.g., first temperature 104-1, first power consumption 106-1, first performance state residency 108-1) as discussed herein. The first revised operating parameters 124-1 may be configured to smoothly transition the first element 102-1 from a current operation point to a new operation point as discussed herein.

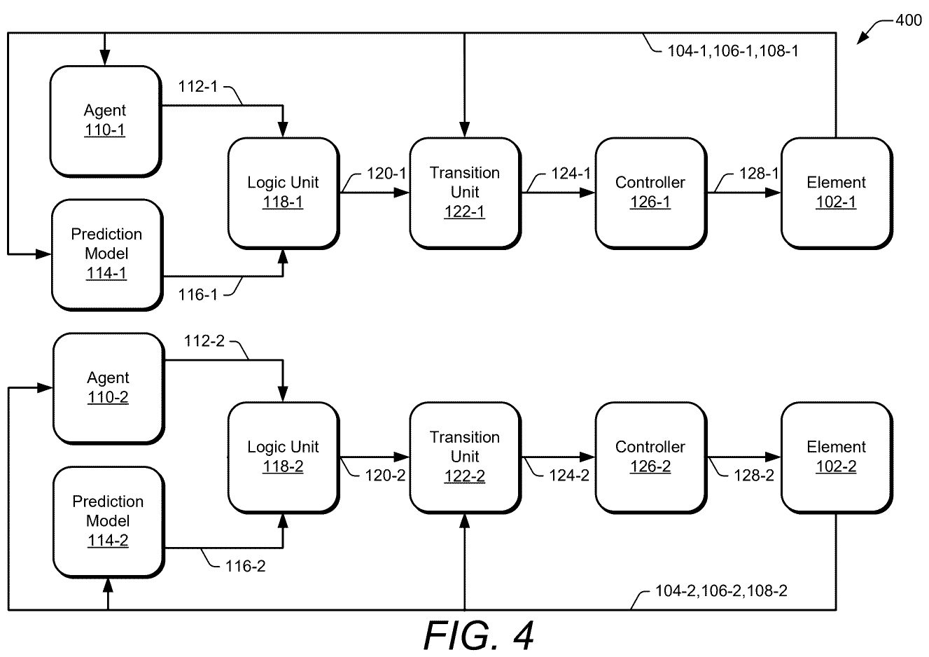

The agent 110 communicates the second estimated operation region 112-2 to a second logic unit 118-2 and the prediction model 114 communicates the second future performance state 116-2 to the second logic unit 118-2. The second logic unit 118-2 is coupled with a second transition unit 122-2 that is coupled to a second controller 126-2 configured to control the second element 102-2 as discussed herein. The second logic unit 118-2 communicates a second logic decision 120-2 to the second transition unit 122-2. The second transition unit 122-2 communicates second revised operating parameters 124-2 to the second controller 126-2. The second revised operating parameters 124-2 are determined based on the second logic decision 120-2 and second operation properties (e.g., second temperature 104-2, second power consumption 106-2, second performance state residency 108-2) as discussed herein. The second revised operating parameters 124-2 may be configured to smoothly transition the second element 102-2 from a current operation point to a new operation point as discussed herein. The number and/or configuration of the components (e.g., agent 110, prediction model 114, first logic unit 118-1, second logic unit 118-2, first transition unit 122-1, second transition unit 122-2, first controller 126-1, second controller 126-2, first element 102-1, second element 102-2) may be varied as would be appreciated by one of ordinary skill in the art. For example, there may be one or more transition units (e.g., first transition unit 122-1, second transition unit 122-2) and each transition unit (e.g., first transition unit 122-1, second transition unit 122-2) may be connected to one or more controllers (e.g., first controller 126-1, second controller 126-2). FIG. 4 illustrates another system that implements aspects of an adaptive controller scheduling framework of semiconductor devices.

FIG. 4 illustrates a system 400 that includes a first element 102-1 of a semiconductor device that is coupled with a first agent 110-1 and a first prediction model 114-1. The system 400 includes a second element 102-2 of the semiconductor device that is coupled with a second agent 110-2 and a second prediction model 114-2. The first agent 110-1 and the first prediction model 114-1 are coupled with a first logic unit 118-1. First operation properties (e.g., first temperature 104-1, first power consumption 106-1, first performance state residency 108-1) of the first element 102-1 are communicated to the first agent 110-1 and the first prediction model 114-1.

As discussed herein, the first agent 110-1 determines a first estimated operation region 112-1 based on one or more of the first operation properties of the first element 102-1 and the first prediction model 114-1 determines a first future performance state 116-1 based on a usage behavior 130 (shown in FIGS. 1 and 2) and one or more of the first operation properties of the first element 102-1. The first agent 110-1 communicates the first estimated operation region 112-1 to a first logic unit 118-1 and the first prediction model 114-1 communicates the first future performance state 116-1 to the first logic unit 118-1. The first logic unit 118-1 determines a first logic decision 120-1 based on the received first estimated operation region 112-1 and first future performance state 116-1 and communicates the first logic decision 120-1 to a first transition unit 122-1.

The first transition unit 122-1 is configured to determine first revised operating parameters 124-1 based on the first operation properties (e.g., first temperature 104-1, first power consumption 106-1, first performance state residency 108-1) and the first logic decision 120-1. The first revised operating parameters 124-1 are communicated to a first controller 126-1 configured to control operation aspects of the first element 102-1. The first revised operating parameters 124-1 may be configured to ensure that the first element 102-1 transitions smoothly to a new operation point as discussed herein.

As discussed above, the second agent 110-2 determines a second estimated operation region 112-2 based on one or more of second operation properties of the second element 102-2 and the second prediction model 114-2 determines a second future performance state 116-2 based on the usage behavior 130 and one or more of the second operation properties of the second element 102-2. The second agent 110-2 communicates the second estimated operation region 112-2 to a second logic unit 118-2 and the second prediction model 114-2 communicates the second future performance state 116-2 to the second logic unit 118-2. The second logic unit 118-2 determines a second logic decision 120-2 based on the received second estimated operation region 112-2 and second future performance state 116-2 and communicates the second logic decision 120-2 to a second transition unit 122-2.

The second transition unit 122-2 is configured to determine second revised operating parameters 124-2 based on the second operation properties (e.g., second temperature 104-2, second power consumption 106-2, second performance state residency 108-2) and the second logic decision 120-2. The second revised operating parameters 124-2 are communicated to a second controller 126-2 configured to control operation aspects of the second element 102-2. The second revised operating parameters 124-2 may be configured to ensure that the second element 102-2 transitions smoothly to a new operation point as discussed herein.

The number and/or configuration of the components (e.g., first agent 110-1, second agent 110-2, first prediction model 114-1, second prediction model 114-2, first logic unit 118-1, second logic unit 118-2, first transition unit 122-1, second transition unit 122-2, first controller 126-1, second controller 126-2, first element 102-1, second element 102-2) may be varied as would be appreciated by one of ordinary skill in the art. For example, one or more transition units (e.g., first transition unit 122-1, second transition unit 122-2) may be connected to each agent (e.g., first agent 110-1, second agent 110-2) and to each prediction model (e.g., first prediction model 114-1, second prediction model 114-2). The example aspects illustrated in FIG. 1 through FIG. 4 may implement aspects of adaptive controller scheduling frameworks for semiconductor devices as would be appreciated by one of ordinary art having the benefit of this disclosure.

### Example Environments and Electronic Devices

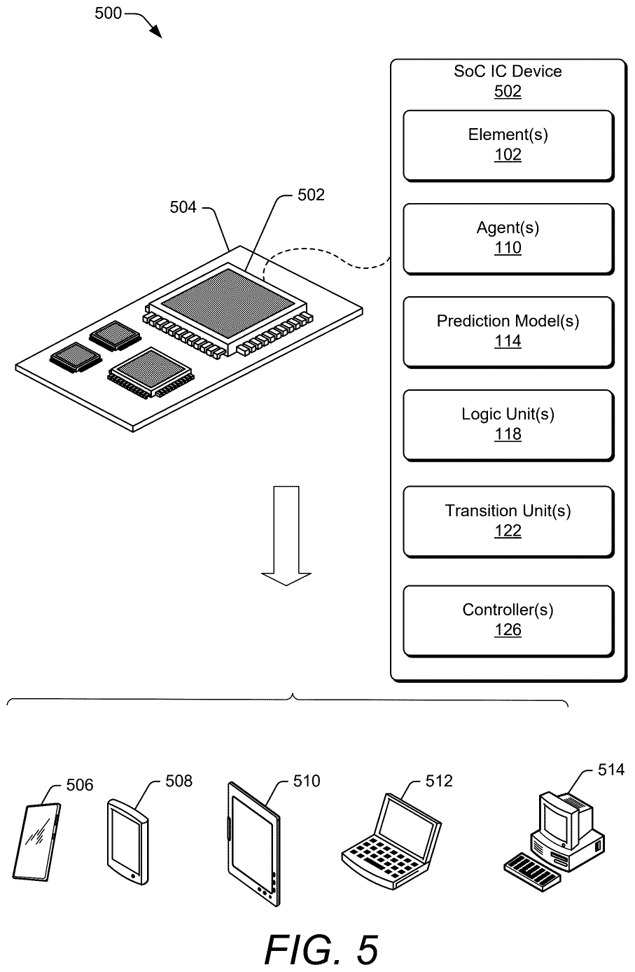

FIG. 5 illustrates an example operating environment 500 in which aspects of an adaptive controller scheduling framework for semiconductor devices can be implemented. As illustrated, an SoC integrated circuit (IC) device 502 may be mounted to a printed circuit board (PCB) 504, which may be included as part of a computing device that implements one or more security protocols. As non-limiting examples, the computing device may be a smartphone 506, a personal digital assistant 508, a tablet 510, a laptop 512, or a workstation 514.

The SoC IC device 502 may include various elements 102 (e.g., GPU, CPU, TPU) that may cause a temperature event (e.g., a sudden increase in temperature) within the SoC IC device 502 due to repeated and/or continued use. For example, a user may repeatedly launch, use, and cancel an application on an electronic device that utilizes the SoC IC device 502. The SoC IC device 502 may include one or more agents 110, predictive models 114, logic units 118, transition units 122, and controllers 126 configured to control at least one or more elements 102 of a semiconductor device. The one or more controllers 126 may be configured to thermally control the at least one or more elements 102 or control an operating frequency of the at least one or more elements 102.

The one or more controllers 126 may control an operation point of one or more elements 102 based on revised operating parameters provided to the controller(s) 126 from the one or more transition units 122. The operation point may control an operating frequency of the element 102. The one or more transition units 122 may determine the revised operating parameters based on the temperature of the element(s) 102, a power consumption of the element(s) 102, or a performance state residency of the element(s) 102 provided to the one or more transition units 122 by the element(s) 102 and a logic decision provided to the one or more transition units 122 from the logic unit(s) 118.

The logic unit(s) 118 may determine the logic decision based on an estimated operation region of the element(s) 102 received from agent(s) 110 and on a future performance state of the element(s) 102 received from prediction model(s) 114. The future performance state of the element(s) 102 may be determined based on a usage behavior of an electronic device that includes the semiconductor device as well as one or more of the temperature of the element 102, the power consumption of the element 102, and the performance state residency of the element 102. The estimated operation region of the element 102 may be determined based on one or more of the temperature of the element 102, the power consumption of the element 102, and the performance state residency of the element 102.

Although the SoC IC device 502 is described in the context of a single SoC IC device including the element(s) 102, agent(s) 110, prediction model(s) 114, logic unit(s) 118, transition unit(s) 122, and controller(s) 126, a combination of discrete IC devices may perform the same functions. For example, a discrete processor IC device (e.g., a processor IC device having element(s) 102, agent(s) 110, prediction model(s) 114, logic unit(s) 118, transition unit(s) 122, and controller(s) 126) may work in combination with a discrete non-volatile memory IC device having the elements to perform one or more functions described herein.

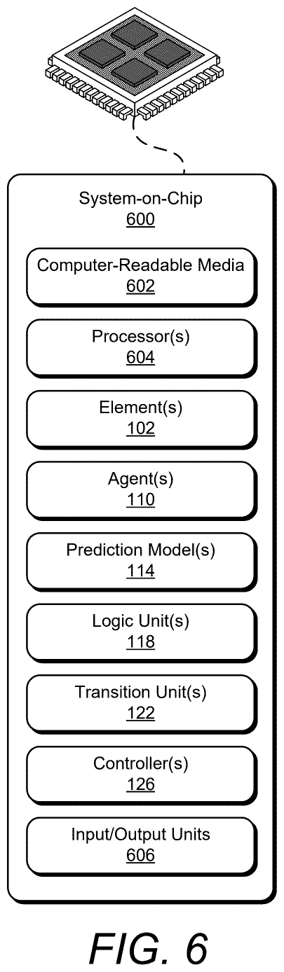

FIG. 6 illustrates an integrated circuit component implemented as an SoC 600 that can implement various aspects of an adaptive controller scheduling framework for semiconductor devices. The SoC 600 may be a single chip including components that are fabricated on the same semiconductor substrate. Alternatively, the SoC 600 may be a number of such chips that are epoxied together. The SoC 600 can be implemented in any suitable device, such as a smartphone, a cellular phone, a netbook, a tablet computer, a server, a wireless router, a network-attached storage, a camera, a smart appliance, a printer, a set-top box, or any other suitable type of device. Although described with reference to an SoC, the entities of FIG. 6 may also be implemented as an application-specific integrated circuit (ASIC), a field-programmable gate array (FPGA), or the like.

The SoC 600 can be integrated with electronic circuitry, including the components described in the operating system listed herein. The SoC 600 can also include an integrated data bus (not shown) that couples the various components of the SoC 600 for data communication between the components. The integrated data bus or other components of the SoC 600 may be exposed or accessed through an external port, such as a joint test action group (JTAG) port. For example, components of the SoC 600 may be tested, configured, or programmed (e.g., flashed) through the external port at different stages of manufacture.

In this example, the SoC 600 includes computer-readable media 602, one or more processors 604, element(s) 102, agent(s) 110, prediction model(s) 114, logic unit(s) 118, transition unit(s) 122, controller(s) 126, and I/O units 606. The controller(s) 126 can be configured to control thermal and/or power consumption aspects of element(s) 102 of a semiconductor device as described herein. The agent(s) 110 are configured to estimate an operation region of element(s) 102 of a semiconductor device as described herein. The prediction model(s) 114 are configured to determine a future performance state of element(s) 102 of a semiconductor device as described herein. The logic unit(s) 118 are configured to dynamically determine logic decisions based on input from the agent(s) 110 and prediction model(s) 114 as discussed herein. The transition unit(s) 122 are configured to provide revised operation parameters to the controller(s) 126 as discussed herein. The controller(s) 126 are configured to control an operation point of the element(s) 102 based on the revised operation parameters as discussed herein. The computer-readable media 602 may be stored in computer-readable storage media, including one or more non-transitory storage devices such as a random-access memory (RAM), dynamic random access memory (DRAM), non-volatile random access memory (NVRAM), or static random access memory (SRAM), read-only memory (ROM), or flash memory, a hard drive, a solid-state drive (SSD), or any type of media suitable for storing electronic instructions, each coupled with a computer system bus.

The computer-readable media 602 of the SoC 600 may include executable code for adaptive controller scheduling frameworks for semiconductor devices. One or more of the processor(s) 604 operably coupled to computer-readable storage media having computer-readable media 602 may execute instructions for adaptive controller scheduling frameworks for semiconductor devices.

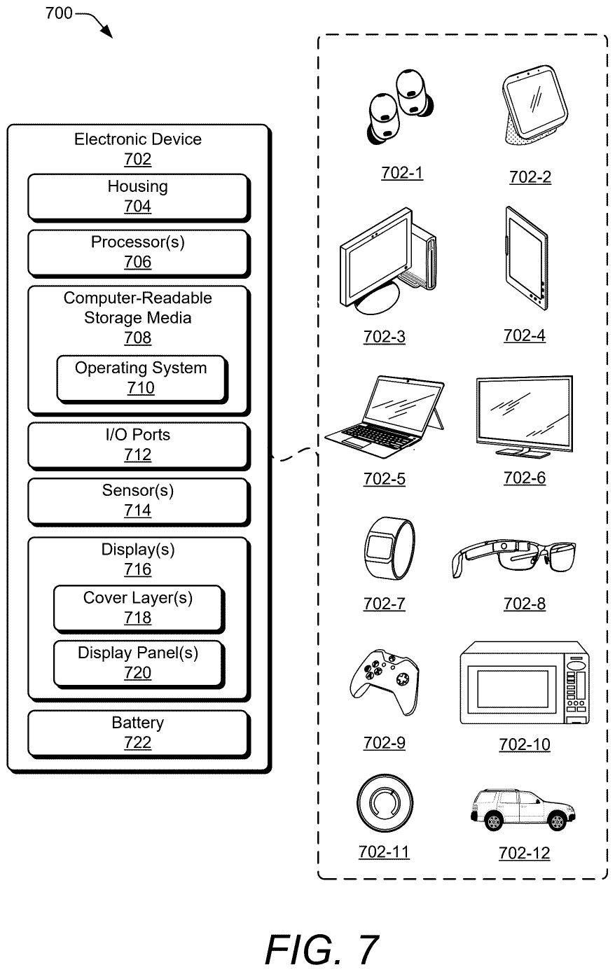

FIG. 7 illustrates an example environment 700 of an example electronic device 702 that includes an adaptive controller scheduling framework for semiconductor devices in accordance with one or more implementations. The electronic device 702 may include additional components and interfaces omitted from FIG. 7 for the sake of clarity. The electronic device 702 is illustrated with various non-limiting example electronic devices 702, including wireless earbuds 702-1, a smart display associated with a home-automation and control system 702-2, a desktop computer 702-3, a tablet 702-4, a laptop 702-5, a television 702-6, a computing watch 702-7, computing glasses 702-8, a gaming system 702-9, a microwave 702-10, a smart thermostat interface 702-11, and an automobile having computing capabilities 702-12. Other devices may also be used, such as wired earbuds, a security camera, a trackpad, a drawing pad, a netbook, an e-reader, other forms of home-automation and control systems, a wall display, a virtual-reality headset, another vehicle (e.g., an e-bike or plane), and other home appliances, to name just a few examples. Note that the electronic device 702 may be wearable, non-wearable but mobile, or relatively immobile (e.g., desktops and appliances), all without departing from the scope of the present teachings.

The electronic device 702 includes a housing 704, which defines at least one internal cavity within which one or more of a plurality of electronic components may be disposed. In implementations, a mechanical frame may define one or more portions of the housing 704. As an example, a mechanical frame can include plastic or metallic walls that define portions of the housing 704. In additional implementations, a mechanical frame may support one or more portions of the housing 704. As an example, one or more exterior housing components (e.g., plastic panels) can be attached to the mechanical frame (e.g., a chassis). In so doing, the mechanical frame physically supports the one or more exterior housing components, which define portions of the housing 704. In implementations, the mechanical frame and/or the exterior housing components may be composed of crystalline or non-crystalline solids. In implementations, the housing 704 may be sealed through the inclusion of one or more displays (e.g., at least one display 716), defining at least one internal cavity.

The electronic device 702 may further include one or more processors 706. The processor(s) 706 can include, as non-limiting examples, an SoC, an application processor (AP), a CPU, or a GPU. The processor(s) 706 generally execute commands and processes utilized by the electronic device 702 and an operating system installed thereon. For example, the processor(s) 706 may perform operations to display graphics of the electronic device 702 on the one or more displays 716 and can perform other specific computational tasks.

The electronic device 702 may also include computer-readable storage media (CRM) 708. The CRM 708 may be a suitable storage device configured to store device data of the electronic device 702, user data, and multimedia data. The CRM 708 may store an operating system 710 that generally manages hardware and software resources (e.g., the applications) of the electronic device 702 and provides common services for applications stored on the CRM 708. The operating system 710 and the applications are generally executable by the processor(s) 706 to enable communication and user interaction with the electronic device 702. One or more processors 706, such as a GPU, perform operations to display graphics of the electronic device 702 on the one or more displays 716 and can perform other specific computational tasks. The processors 706 can be single-core or multiple-core processors.

The electronic device 702 may also include input/output (I/O) ports 712. The I/O ports 712 allow the electronic device 702 to interact with other devices or users. The I/O ports 712 may include any combination of internal or external ports, such as universal serial bus (USB) ports, audio ports, serial advanced technology attachment (SATA) ports, peripheral component interconnect standard (PCI)-express based ports or card-slots, secure digital input/output (SDIO) slots, and/or other legacy ports.

The electronic device 702 may further include one or more sensors 714. The sensor(s) 714 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an under-display fingerprint sensor, or an ambient light sensor (e.g., photodetector). In implementations, the electronic device 702 includes one or more of a front-facing sensor(s) and a rear-facing sensor(s). An element 102 of the semiconductor device may be the various components of the electronic device 702. For example, the element 102 may be processor(s) 706, computer-readable storage media 708, I/O ports 712, sensors 714, display(s) 716, a battery 722, or the like. The operating system 710 and/or various processor(s) 706 of the electronic device 702 include operating instructions to enable an adaptive controller scheduling framework for semiconductor devices to control the transition of various components of the electronic device 702 between operating points to ensure such transitions are smooth.

The electronic device 702 may include the one or more displays 716, one or more cover layers 718, and one or more display panels 720. The cover layer(s) 718 may be implemented as any of a variety of transparent materials including polymers (e.g., plastic, acrylic) or glasses.

The electronic device 702 further includes a battery 722. In implementations, the battery 722 is a rechargeable battery that is configured to store and supply electrical energy. The rechargeable battery 722 may be any suitable rechargeable battery, such as a lithium-ion (Li-ion) battery.

### Example Method

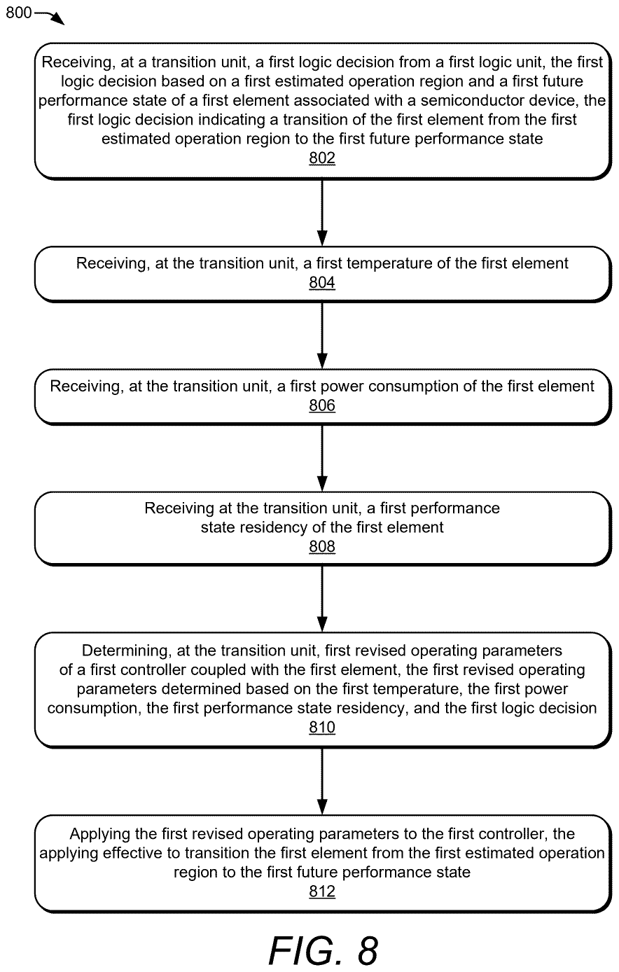

FIG. 8 is a flowchart that illustrates a method 800 for an adaptive controller scheduling framework for semiconductor devices, which includes operations 802 through 812.

At step 802, a first logic decision from a first logic unit is received at a transition unit. The first logic decision is based on a first estimated operation region and a first future performance state of a first element associated with a semiconductor device. The first logic decision indicates a transition of the first element from the first estimated operation region to the first future performance state. For example, a transition unit (e.g., transition unit 122) receives a first logic decision (e.g., first logic decision 120-1) from a logic unit (e.g., logic unit 118). The logic unit (e.g., logic unit 118) determines the first logic decision (e.g., first logic decision 120-1) based on a first estimated operation region (e.g., first estimated operation region 112-1) received from an agent (e.g., agent 110) and on a first future performance state (e.g., first future performance state 116-1) received from a prediction model (e.g., prediction model 114). The first logic decision (e.g., first logic decision 120-1) indicates that a first element (e.g., first element 102-1) should transition from the first estimated operation region (e.g., first estimated operation region 112-1) to the first future performance state (e.g., first future performance state 116-1).

At step 804, a first temperature of the first element is received at the transition unit. For example, the transition unit (e.g., transition unit 122) is coupled with the first element (e.g., first element 102-1) and receives a first temperature (e.g., first temperature 104-1) from the first element (e.g., first element 102-1).

At step 806, a first power consumption of the first element is received at the transition unit. For example, the transition unit (e.g., transition unit 122) is coupled with the first element (e.g., first element 102-1) and receives a first power consumption (e.g., first power consumption 106-1) from the first element (e.g., first element 102-1).

At step 808, a first performance state residency of the first element is received at the transition unit. For example, the transition unit (e.g., transition unit 122) is coupled with the first element (e.g., first element 102-1) and receives a first performance state residency (e.g., first performance state residency 108-1) from the first element (e.g., first element 102-1).

At step 810, the transition unit determines first revised operating parameters of a first controller coupled with the first element, the first revised operating parameters determined based on the first temperature, the first power consumption, the first performance state residency, and the first logic decision. For example, the transition unit (e.g., transition unit 122) determines first revised operating parameters (e.g., first revised operating parameters 124-1) of a first controller (e.g., first controller 126-1) coupled with the first element (e.g., first element 102-1). The first revised operating parameters (e.g., first revised operating parameters 124-1) are determined based on the first temperature (e.g., first temperature 104-1), the first power consumption (e.g., first power consumption 106-1), and the first performance state residency (e.g., first performance state residency 108-1). The first revised operating parameters (e.g., first revised operating parameters 124-1) may be configured to ensure a smooth transition of the first element (e.g., first element 102-1) as discussed herein.

At step 812, the first revised operating parameters are applied to the first controller, the applying effective to transition the first element from the first estimated operation region to the first future performance state. For example, the first controller (e.g., first controller 126-1) applies the first revised operating parameters (e.g., first revised operating parameters 124-1) to the first element (e.g., first element 102-1), the application of the first revised operating parameters (e.g., first revised operating parameters 124-1) effective to transition the first element (e.g., first element 102-1) from the first estimated operation region (e.g., first estimated operation region 112-1) to the first future performance state (e.g., first future performance state 116-1).

For the methods described herein and the associated flowchart(s) and flow diagram(s), the orders in which operations are shown and/or described are not intended to be construed as a limitation. Instead, any number or combination of the described method operations can be combined in any order to implement a given method or an alternative method, including by combining operations from the flowchart or diagram and the earlier-described techniques into one or more methods. Operations may also be omitted from or added to the described methods. Further, described operations can be implemented in fully or partially overlapping manners.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for adaptive controller scheduling frameworks for semiconductor devices have been described in language specific to certain features and/or methods, the subject of the appended claims is not necessarily limited to the specific features or methods described. Rather, the specific features and methods are disclosed as example implementations for adaptive controller scheduling frameworks for semiconductor devices.

What is claimed is:

1. A method comprising:
receiving, at an transition unit, a first logic decision from a logic unit, the first logic decision determined based on a first estimated operation region and a first future performance state of a first element associated with a semiconductor device, the first logic decision indicating a transition of the first element from the first estimated operation region to the first future performance state;
receiving, at the transition unit, a first temperature of the first element;
receiving, at the transition unit, a first power consumption of the first element;
receiving, at the transition unit, a first performance state residency of the first element;
determining, by the transition unit, first revised operating parameters of a first controller coupled with the first element and the transition unit, the first revised operating parameters determined based on the first temperature, the first power consumption, the first performance state residency, and the first logic decision; and
applying the first revised operating parameters to the first controller, the applying effective to transition the first element from the first estimated operation region to the first future performance state.

2. The method of claim 1, wherein the applying first revised operating parameters to the first controller further comprises:
applying a first series of revised operating parameters of a predetermined timescale to the first controller, the applying effective to transition, in two or more steps, the first element from the first estimated operation region to the first future performance state, the first series of revised operating parameters configured to provide a smooth transition from the first estimated operation region to the first future performance state.

3. The method of claim 2, further comprising:
receiving, at an agent coupled with the first element and the logic unit, the first temperature of the first element, the first power consumption of the first element, and the first performance state residency of the first element;
determining, by the agent, the first estimated operation region of the first element;
receiving, at a prediction model coupled with the first element and the logic unit, the first temperature of the first element, the first power consumption of the first element, and the first performance state residency of the first element; and
determining, by the prediction model, the first future performance state of the first element.

4. The method of claim 3, wherein the first future performance state is determined based, at least partially, on usage behavior of an electronic device that includes the semiconductor device.

5. The method of claim 4, further comprising:
determining, by the prediction model, the usage behavior, wherein the usage behavior is determined using a machine-learned model or artificial intelligence.

6. The method of claim 4, wherein the first estimated operation region is determined based on at least one of the first temperature, the first power consumption, and the first performance state residency, and the first future performance state is determined based on the usage behavior and at least one of the first temperature, the first power consumption, and the first performance state residency.

7. The method of claim 4, wherein the first estimated operation region is determined based on at least two of the first temperature, the first power consumption, and the first performance state residency, and the first future performance state is determined based on the usage behavior and at least two of the first temperature, the first power consumption, and the first performance state residency.

8. The method of claim 4, wherein the first estimated operation region is determined based on the first temperature, the first power consumption, and the first performance state residency, and the first future performance state is determined based on the usage behavior and the first temperature, the first power consumption, and the first performance state residency.

9. The method of claim 4, further comprising:
applying, from the first controller, to the first element a first series of throttling actions determined based on the first series of revised operating parameters.

10. The method of claim 1, further comprising:
receiving, at the transition unit, a second logic decision from the logic unit, the second logic decision determined based on a second estimated operation region and a second future performance state of a second element associated with the semiconductor device, the second logic decision indicating a transition of the second element from the second estimated operation region to the second future performance state;
receiving, at the transition unit, a second temperature of the second element;
receiving, at the transition unit, a second power consumption of the second element;
receiving, at the transition unit, a second performance state residency of the second element;
determining, by the transition unit, second revised operating parameters of a second controller coupled with the second element and the transition unit, the second revised operating parameters determined based on the second temperature, the second power consumption, the second performance state residency, and the second logic decision; and
applying the second revised operating parameters to the second controller, the applying effective to transition the second element from the second estimated operation region to the second future performance state.

11. The method of claim 10, wherein the applying first revised operating parameters to the first controller and applying second revised operating parameters to the second controller comprises:
applying a first series of revised operating parameters of a first predetermined timescale to the first controller, the applying effective to transition, in two or more steps, the first element from the first estimated operation region to the first future performance state, the first series of revised operating parameters configured to provide a smooth transition from the first estimated operation region to the first future performance state; and
applying a second series of revised operating parameters of a second predetermined timescale to the second controller, the applying effective to transition, in two or more steps, the second element from the second estimated operation region to the second future performance state, the second series of revised operating parameters configured to provide a smooth transition from the second estimated operation region to the second future performance state.

12. The method of claim 11, further comprising:
applying, from the first controller, to the first element a first series of throttling actions determined based on the first series of revised operating parameters; and
applying, from the second controller, to the second element a second series of throttling actions determined based on the second series of revised operating parameters.

13. A system comprising:
a first element of a semiconductor device, the first element having a first temperature, a first power consumption, and a first performance state residency;
a first agent coupled with the first element, the first agent configured to receive the first temperature, the first power consumption, and the first performance state residency from the first element and determine a first estimated operation region of the first element determined based on at least one the first temperature, the first power consumption, and the first performance state residency;
a first prediction model coupled with the first element, the first prediction model configured to receive the first temperature, the first power consumption, and the first performance state residency from the first element and determine a first future performance state of the first element determined based on usage behavior of an electronic device utilizing the semiconductor device and at least one of the first temperature, the first power consumption, and the first performance state residency;
a first logic unit coupled with the first agent and the first prediction model, the first logic unit configured to receive the first estimated operation region from the first agent and the first future performance state from the first prediction model and determine a first logic decision determined based on the first estimated operation region and the first future performance state, the first logic decision indicating a transition of the first element from the first estimated operation region to the first future performance state;
a first transition unit coupled with the first logic unit and the first element, the first transition unit configured to receive the first logic decision from the first logic unit and the first temperature, the first power consumption, and the first performance state residency from the first element and determine first revised operating parameters determined based on the first logic decision, the first temperature, the first power consumption, and the first performance state residency; and
a first controller coupled with the first transition unit and the first element, the first controller configured to receive the first revised operating parameters from the first transition unit and apply at least a first throttling action to the first element determined based on the first revised operating parameters, the application of the first throttling action to the first element effective to change an operation point of the first element.

14. The system of claim 13, wherein the first estimated operation region is determined based on at least two of the first temperature, the first power consumption, and the first performance state residency, and the first future performance state is determined based on the usage behavior and at least two of the first temperature, the first power consumption, and the first performance state residency.

15. The system of claim 13, wherein the first estimated operation region is determined based on the first temperature, the first power consumption, and the first performance state residency, and the first future performance state is determined based on the usage behavior and the first temperature, the first power consumption, and the first performance state residency.

16. The system of claim 15, further comprising:
a second element of the semiconductor device, the second element having a second temperature, a second power consumption, and a second performance state residency;
the first agent coupled with the second element, the first agent configured to receive the second temperature, the second power consumption, and the second performance state residency from the second element and determine a second estimated operation region of the second element determined based on the second temperature, the second power consumption, and the second performance state residency;
the first prediction model coupled with the second element, the first prediction model configured to receive the second temperature, the second power consumption, and the second performance state residency from the second element and determine a second future performance state of the second element determined based on the usage behavior and the second temperature, the second power consumption, and the second performance state residency;
the first logic unit configured to receive the second estimated operation region from the first agent and the second future performance state from the first prediction model and determine a second logic decision determined based on the second estimated operation region and the second future performance state, the second logic decision indicating a transition of the second element from the second estimated operation region to the second future performance state;
the first transition unit coupled with the second element, the first transition unit configured to receive the second logic decision from the first logic unit and the second temperature, the second power consumption, and the second performance state residency from the second element and determine second revised operating parameters determined based on the second logic decision, the second temperature, the second power consumption, and the second performance state residency; and
the first controller coupled with the second element, the first controller configured to receive the second revised operating parameters from the first transition unit and apply at least a second throttling action to the second element determined based on the second revised operating parameters, the application of the second throttling action to the second element effective to change an operation point of the second element.

17. The system of claim 15, further comprising:
a second element of the semiconductor device, the second element having a second temperature, a second power consumption, and a second performance state residency;
the first agent coupled with the second element, the first agent configured to receive the second temperature, the second power consumption, and the second performance state residency from the second element and determine a second estimated operation region of the second element determined based on the second temperature, the second power consumption, and the second performance state residency;
the first prediction model coupled with the second element, the first prediction model configured to receive the second temperature, the second power consumption, and the second performance state residency from the second element and determine a second future performance state of the second element determined based on the usage behavior and the second temperature, the second power consumption, and the second performance state residency;
a second logic unit coupled with the first agent and the first prediction model, the second logic unit configured to receive the second estimated operation region from the first agent and the second future performance state from the first prediction model and determine a second logic decision determined based on the second estimated operation region and the second future performance state, the second logic decision indicating a transition of the second element from the second estimated operation region to the second future performance state;
a second transition unit coupled with the second logic unit and the second element, the second transition unit configured to receive the second logic decision from the second logic unit and the second temperature, the second power consumption, and the second performance state residency from the second element and determine second revised operating parameters determined based on the second logic decision, the second temperature, the second power consumption, and the second performance state residency; and
a second controller coupled with the second transition unit and the second element, the second controller configured to receive the second revised operating parameters from the second transition unit and apply at least a second throttling action to the second element determined based on the second revised operating parameters, the application of the second throttling action to the second element effective to change an operation point of the second element.

18. The system of claim 15, further comprising:
a second element of the semiconductor device, the second element having a second temperature, a second power consumption, and a second performance state residency;
a second agent coupled with the second element, the second agent configured to receive the second temperature, the second power consumption, and the second performance state residency from the second element and determine a second estimated operation region of the second element determined based on the second temperature, the second power consumption, and the second performance state residency;
a second prediction model coupled with the second element, the second prediction model configured to receive the second temperature, the second power consumption, and the second performance state residency from the second element and determine a second future performance state of the second element determined based on the usage behavior and the second temperature, the second power consumption, and the second performance state residency;
a second logic unit coupled with the second agent and the second prediction model, the second logic unit configured to receive the second estimated operation region from the second agent and the second future performance state from the second prediction model and determine a second logic decision determined based on the second estimated operation region and the second future performance state, the second logic decision indicating a transition of the second element from the second estimated operation region to the second future performance state;
a second transition unit coupled with the second logic unit and the second element, the second transition unit configured to receive the second logic decision from the second logic unit and the second temperature, the second power consumption, and the second performance state residency from the second element and determine second revised operating parameters determined based on the second logic decision, the second temperature, the second power consumption, and the second performance state residency; and
a second controller coupled with the second transition unit and the second element, the second controller configured to receive the second revised operating parameters from the second transition unit and apply at least a second throttling action to the second element determined based on the second revised operating parameters, the application of the second throttling action to the second element effective to change an operation point of the second element.

19. One or more non-transitory computer storage media encoded with instructions that when executed by a computing device cause the computing device to perform operations comprising:
determining, by an agent coupled with an element of a semiconductor device, an estimated operation region of the element, the estimated operation region determined based on one or more of a temperature of the element, a power consumption of the element, and a performance state residency of the element;
determining, by a prediction model coupled with the element, a future performance state of the element, the future performance state of the element determined based on usage behavior of an electronic device that includes the semiconductor device and one or more of the temperature, the power consumption, and the performance state residency of the element;
determining, by a logic unit coupled with the agent and the prediction model, a logic decision determined based on the estimated operation region of the element and the future performance state of the element, the logic decision indicating a transition of the element from the estimated operation region to the future performance state;
determining, by a transition unit coupled with the logic unit and the element, revised operating parameters for a controller coupled with the element, the revised operating parameters determined based on the logic decision, the temperature of the element, the power consumption of the element, and the performance state residency of the element; and
applying the revised operating parameters to the controller, the applying effective to transition the element from the estimated operation region to the future performance state.

20. The one or more non-transitory computer storage media of claim 19, wherein applying the revised operating parameters to the controller further comprises:
applying a series of revised operating parameters during a predetermined timescale to the controller, the applying effective to transition, in two or more steps, the element from the estimated operation region to the future performance state, the series of revised operating parameters configured to provide a smooth transition from the estimated operation region to the future performance state.
